(19) United States
(12) Patent Application Publication
(10) Pub. No.: US 2009/0150993 A1
(43) Pub. Date: Jun. 11, 2009

(54) Mobile Device with Frequently Operated Biometric Sensors

(75) Inventor: Patrick TILLEY, Coram, NY (US)

Correspondence Address: FAY KAPLUN & MARCIN, LLP, 150 BROADWAY, SUITE 702, NEW YORK, NY, 10038, US

(73) Assignee: Symbol Technologies, Inc., Holtsville, NY (US)

(21) Appl. No.: 11/953,273

(22) Filed: Dec. 10, 2007

(51) Int. Cl. G06F 21/00

(52) U.S. Cl. 726/19

(57) ABSTRACT

A mobile device having a user input component receiving input from a user and a biometric sensor incorporated in the user input component collecting biometric data from the user when the user input component is receiving the input, wherein the input is non-biometric data. In addition, a system and method for receiving input from a user via a user input component of a mobile device and collecting biometric data from the user via a biometric sensor incorporated within the user input component when receiving the input from the user, wherein the input is non-biometric data.

### FIELD OF THE INVENTION

The present invention relates generally to a mobile device having a biometric sensor. Specifically, a biometric sensor is incorporated within another component of the mobile device such as a keypad key, device control, or bar code scan trigger to enable frequent updates of biometric captures.

### BACKGROUND

Mobile units (MU) are constantly being improved to have a smaller size and a lighter weight. While becoming smaller and lighter, users constantly desire additional functionalities to be built into the mobile devices. In some instances, these additional functionalities require user interfaces. However, as the mobile units become smaller, there is no room to add additional user interfaces for these functionalities.

Mobile computers are becoming ubiquitous in the workplace and many are used to access systems containing restricted sensitive or confidential information. Many of these devices are used in a shared mode or are used in the performance of physical work where the mobile unit (MU) may be put down for a brief period where it may be subject to being used by an unauthorized person. It is not practical to log off and log onto the device continuously during the day.

### SUMMARY OF THE INVENTION

A mobile device having a user input component receiving input from a user and a biometric sensor incorporated in the user input component collecting biometric data from the user when the user input component is receiving the input, wherein the input is non-biometric data.

In addition, a method for receiving input from a user via a user input component of a mobile device and collecting biometric data from the user via a biometric sensor incorporated within the user input component when receiving the input from the user, wherein the input is non-biometric data.

### DESCRIPTION OF THE DRAWINGS

FIG. 1 shows components of a mobile unit according to an exemplary embodiment of the present invention.

FIG. 2 shows a method of authentication using biometric data collected according to an exemplary embodiment of the present invention.

FIG. 3 shows a block diagram of a mobile unit according to an exemplary embodiment of the present invention.

FIG. 4 shows components of a scanning mobile unit according to an exemplary embodiment of the present invention.

### DETAILED DESCRIPTION

The exemplary embodiments of the present invention may be further understood with reference to the following description and the appended drawings, wherein like elements are referred to with the same reference numerals. The exemplary embodiments of the present invention describe a mobile unit (“MU”) having a biometric sensor incorporated within another component of the MU. Specifically, the exemplary embodiments of the present invention provide for a biometric sensor to be implemented within another user interface of the MU such as a key of a keypad or a trigger. The MU, the biometric sensor and the other user interface will be discussed in more detail below.

As described above, it is not practical for a user to log off and log onto a device continuously. Thus, a biometric sensor on a common work interface (commonly used key or a trigger in the case of a bar code scanner) allows for the authentication status of the user to be tracked in an almost continuous manner. The exemplary embodiments of the present invention integrates a biometric sensor into an enter key or a spacebar (or any other available key or actuator) of a mobile device keypad. It also applies to any other keys in a keypad that can accommodate a biometric sensor. Also, on bar code scanning terminals the scan enable key (e.g., trigger) can also be used to host the biometric sensor. Biometric sensors have reached the point where their size enables them to be compatible with integration into a mobile device keypad. These include any touch or swipe biometric devices (e.g. thermal, semiconductor, imaging).

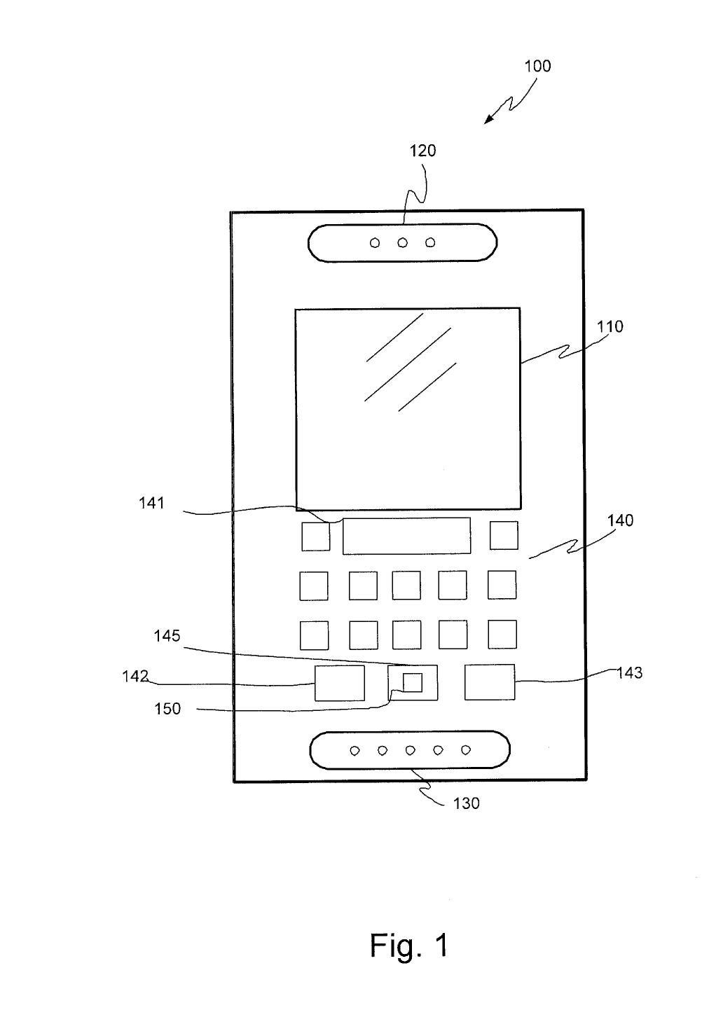

FIG. 1 shows an MU 100 according to an exemplary embodiment of the present invention. The MU 100 may be any portable electronic device that utilizes a portable power supply (e.g., battery, capacitor, super capacitor, etc.). For example, the MU 100 may be a mobile computer, a personal digital assistant (PDA), a laptop, a pager, a cell phone, a radio frequency identification device, a scanner, image capture device, etc.

The exemplary MU 100 includes various user interface components including a display 110, a speaker 120, a microphone 130 and a keypad 140. Those skilled in the art will understand that the user interface components illustrated in FIG. 1 are only exemplary and that other MUs may have less or additional user interface components in different configurations. As shown in FIG. 1, the keypad 140 includes a plurality of keys. Each of the keys may have various functions associated with the pressing of the key including alpha input, numeric input, function input, etc. In this exemplary embodiment, the space key 145 also includes a biometric sensor 150. Thus, as a user positions their finger (or other body part) on the space key 145, the biometric sensor 150 incorporated within the space key 145 may collect biometric information from the user.

A biometric sensor may be any device that captures a distinctive human characteristic. Examples of biometric sensors include fingerprint scanners (fingerprints), retina pattern analyzers (retina images), voice analyzers (voice), etc. In the exemplary embodiment of MU 100, the biometric sensor 150 may be a fingerprint scanner because a user will be pressing the space key 145 with their finger. Thus, the type of biometric data that may be most easily collected by a biometric sensor 150 incorporated within the space key 145 is fingerprint data. However, those skilled in the art will understand that other types of biometric sensors may be incorporated within the space key 145 or another user interface of the MU 100.

The addition of the biometric sensor 150 to the space key 145 allows the MU 100 to incorporate another functionality, i.e., the collection of biometric data, without increasing an amount of the surface area of the MU 100 that is dedicated to user interfaces. It should be noted that the incorporation of the biometric sensor 150 into the space key 145 is only exemplary and that it may be possible to incorporate the biometric sensor 150 into any of the keys of the keypad 140, e.g., the enter key, the space key, etc. For example, in the exemplary embodiment of FIG. 1, the biometric sensor 150 may also be incorporated into the scan key 141, the enter key 142 or the soft key 143. The selection of the keys 141, 142, 143 and 145 may be based on the fact that a user will use these keys relatively frequently during use of the keypad 140. In addition, it is common for these keys to be slightly larger than other keys on the keypad 140, meaning that a larger key can more easily accommodate the biometric sensor 150. However, frequent use or a larger size of the key is not a requirement for incorporation of the biometric sensor 150.

Furthermore, it should be noted that the biometric sensor 150 does not need to be incorporated within a key of the keypad 140 of the MU 100. For example, the MU 100 may have additional buttons or keys on the side of the device (not shown). The biometric sensor may be incorporated within these side keys. In another example, the display 110 may be a touch sensitive display. The touch sensitive display 110 may include a biometric sensor 150 such that each time the user touched the display 110 (or a specific portion of the display 110), biometric information may be collected by the incorporated biometric sensor 150.

Those skilled in the art will understand that there are various types of biometric sensors for collecting fingerprint information such as thermal sensors, capacitance sensors, imaging sensors, etc. The biometric sensor(s) 150 that are incorporated into the user interfaces of the MU 100 may include any of these types of fingerprint sensors or any other type of biometric sensor (e.g., retinal scanner, speech analyzer, etc.).

The incorporation of the biometric sensor 150 into the space key 145 (or any other user interface device) of the MU 100 allows for a relatively constant collection of biometric information from the user during operation of the device. This constantly collected biometric information may be used in a variety of manners such as authenticating users, locating users, etc.

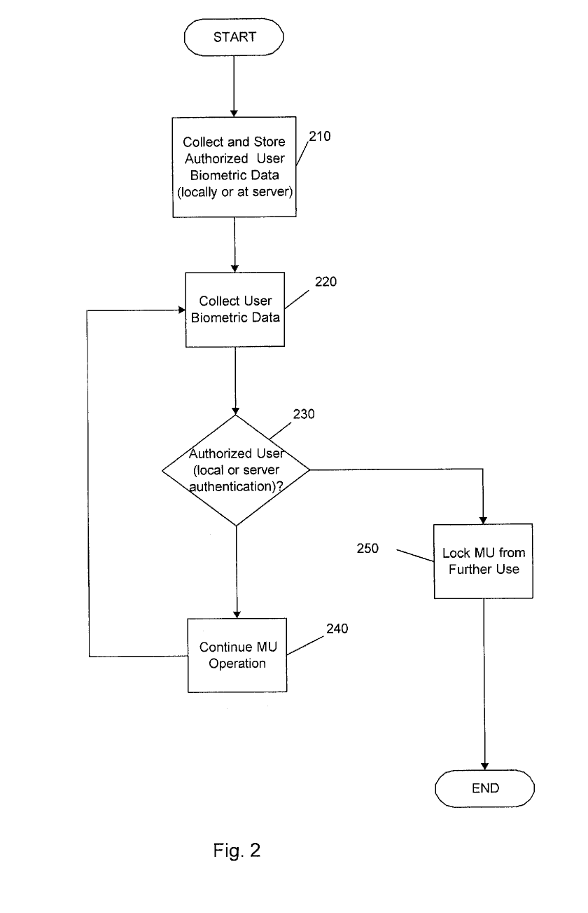

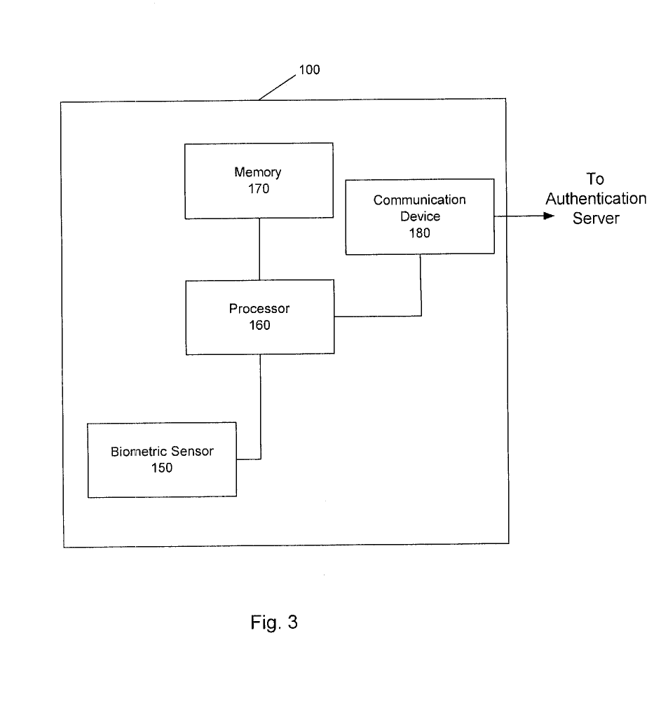

FIG. 2 shows an exemplary method 200 of collecting and using biometric information for authentication purposes via the incorporated biometric sensor 150. The exemplary method 200 will be described with reference to the MU 100 of FIG. 1 and the block diagram of MU 100 of FIG. 3. The block diagram of FIG. 3 shows the MU 100 having the biometric sensor 150, a processor 160 and a memory 170. The specific functionality of these components relative to the method 200 will be described in greater detail below.

Referring back to FIG. 2, the method 200 begins in step 210 where an authorized user's biometric data is collected and stored or forwarded to an authentication server. The authorized user's biometric data may be collected by the MU 100 or by another device. If the authorized user's biometric data is collected by the MU 100, the user would, for example, place their finger over the biometric sensor 150 of the space key 145. The biometric sensor 150 collects the fingerprint data from the user and sends the biometric data to the processor 160 which then stores the captured biometric (template) data in the memory 170 for later use. Those skilled in the art will understand that depending on the complexity of the biometric sensor 150, the biometric sensor 150 may be able to directly store the biometric data to the memory 170. However, in the general case, the processor 160 may receive all input data for the MU 100 and may also perform additional processing on the biometric data or an network server may process the biometric data and determine the authenticity of the user before the biometric data is stored in the memory 170.

If the authorized user's biometric data is collected by a different device, the biometric data can either be moved to the memory 170 of the MU 100 or the data is stored on a centralized server by transmitting the data via the communications device 180. For example, if the MU 100 is equipped to receive wireless communications or some other network interface, the biometric data may be wirelessly communicated to the MU 100 and stored in the memory 170 or consequently, the communication device 180 is used to contact the server for authentication of the biometric data. In another exemplary embodiment, the memory 170 may be a non-volatile memory such as a flash memory that may be embodied as a removable card that may be inserted into the MU 100. The flash memory may have the authorized user's biometric data stored therein for use in the MU 100.

In step 220, a user may begin operation of the MU 100 by placing their finger over the biometric sensor 150 incorporated within the appropriate key 145 or the bar code scanner trigger. The biometric sensor 150 collects the fingerprint data from the user 150 and sends the biometric data to the processor 160. The authentication processor may reside on a server instead of the MU 100. In step 230, the processor 160 retrieves the stored biometric data for the authorized user and compares the stored biometric data to the collected biometric data for the current user. If the comparison of the collected biometric data to the stored biometric data does not produce a match in step 230 (e.g., the user is not authorized), the process continues to step 250 where the MU 100 is locked from further use because an unauthorized user is attempting to use the MU 100. Network alerts may be generated when such an action occurs. All biometric sensor activity may be kept in a local file or captured by the authentication server for the purpose of monitoring usage of the MU 100. It should be noted that while FIG. 2 shows the method ending after step 250, an authorized user may be able to unlock the MU 100 after it has been locked by inputting the authorized biometric data. Thus, the process may loop back to step 210 or 220 after the MU 100 is locked.

If the stored biometric data (on the MU or server) matches the collected biometric data in step 230, the current user is an authorized user of the MU 100 and the process continues to step 240 where continued operation of the MU 100 proceeds. As the user continues to use the MU 100, the user will periodically use the space key 145 (or other user interface of MU 100) having the incorporated biometric sensor 150. When this occurs, the biometric sensor will collect additional biometric data from the user in step 220 and the comparison of step 230 will be repeated. Thus, the user may be re-authenticated multiple times during use of the MU 100 to verify that the MU 100 remains in the possession of the authorized user. If at any time the authentication fails, the process will continue to step 250 where the MU 100 will be locked and the non-authorized user will be prevented from using the MU 100. The MU 100 then goes back into the mode where it is capturing biometric data.

Because the biometric sensor 150 is incorporated within the space key (or other key/actuator) 145, the biometric data may be collected relatively often during the use of the MU 100 without becoming burdensome on the user to constantly place or swipe their finger over a stand alone biometric sensor that is placed on some other portion of the MU 100. That is, the biometric sensor 150 allows the user to constantly enter biometric data without stopping normal use of the MU 100.

It should be noted that during use of the MU 100, the user may not always hold their finger on the biometric sensor 150 incorporated within the space key 145 for a long enough period to collect complete biometric data. Thus, in one exemplary embodiment, the process 200 may include multiple attempts to authenticate the user after the initial authentication in recognition of the fact that only partial data may have been collected in some instances. For example, the method 200 may include a threshold of attempts to re-authenticate a user after a valid authentication (e.g., 10 times). This may be implemented, for example, as a separate step between steps 230 and 250. If the authentication fails less than the threshold amount (e.g., between 1 and 10 times), the MU 100 may continue to operate by continuing back to step 220, but the processor 160 may increment a counter for each failed authentication. When the number of failed authentications exceeds the threshold, the method will then proceed to step 250 to lock the MU 100.

In a further exemplary embodiment, the biometric sensor 150 may collect different portions of partial data each time the user uses the space key 145 (e.g., only a portion of a fingerprint). This partial data may then be compared to the stored data and a confidence level may be set for authentication purposes, e.g., if there is a partial match of greater than x %, the user may be considered an authorized user.

In a still further exemplary embodiment, the biometric sensor 150 may collect different portions of partial data each time the user uses the data input including the biometric sensor (e.g., the space or enter key 145). This partial data may be collected and stored and used to reconstruct the complete (or near complete) biometric data (e.g., fingerprint for comparison). The reconstructed fingerprint data may then be compared to the stored authorized fingerprint data for authentication purposes.

It should also be noted that a single MU 100 may have multiple authorized users biometric data stored in the memory 170 or authentication server via the network interface. Thus, any of these authorized users may use the MU 100. In addition, the initial collection of the biometric data for the MU 100 may be performed during an initial configuration of the MU 100, e.g., when the MU 100 comes out of the box and is initially configured for use. In another example, the MU 100 may collect the authorized user biometric data each time the MU 100 is started. For example, the MU 100 may be stored in a secure location and the authorized user may pick up the MU 100 at the start of each shift. The user may log into the MU 100 to set the user as the authorized user for that shift.

The collected biometric data may also be used for other purposes than user authentication. For example, it may also be used to identify a user of a particular MU. In one exemplary embodiment, there may be biometric data for a plurality of authorized users loaded into memories of a plurality of MUs or the plurality of MUs may use the network interface to an authentication server. The authorized users may select any of the plurality of MUs at the beginning of a shift and log into the devices using the biometric sensor to collect the biometric data. This biometric data may then be used to identify the individual user that has logged into the particular MU. This user data may then be sent to a central location for identification and tracking purposes. Those skilled in the art will understand that the above uses for the biometric data are only exemplary and that there are many other uses for the biometric data.

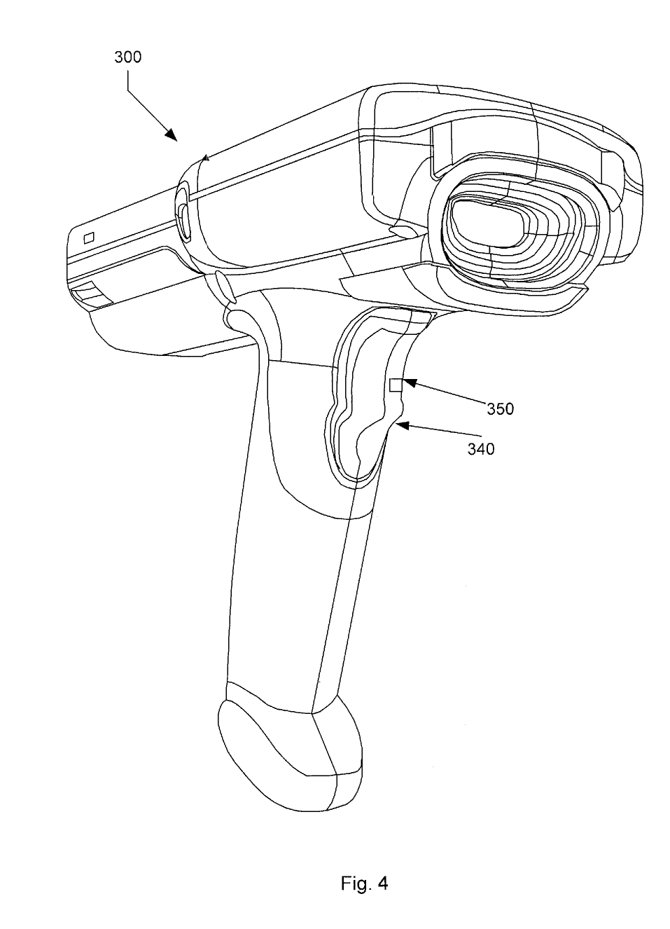

FIG. 4 shows another example of an MU 300 having a biometric sensor 350 integrated into a user input device 340. In this exemplary embodiment, the MU 300 is a scanning device (e.g., laser scanner, imaging scanner, etc.). The MU 300 has a scan enable key in the form of a trigger 340. Each time a user desires to initiate a scan, the user will depress the trigger 340. Thus, the user's finger will be on the trigger 340 substantial amount of the time that the MU 300 is operating. Thus, the integration of the biometric sensor 350 period into the trigger 340 allows for the user's biometric data (e.g., fingerprint) to be continuously collected during the operation of the MU 300 without interference with the user's normal operation of the MU 300. The collected biometric data may be used in the same manner as described above.

It should also be noted that a user of either the MU 100 or 300 may also collect biometric data from third parties using the biometric sensors 150 and 350, respectively. That is, the user of the MU 100, to verify a third party's identity may ask the third party to place their finger on the space key 145 in order for the biometric sensor 150 to collect biometric data from the third party. The MU 100 may include an application program related to the collection of biometric data from a third party.

The exemplary embodiments of the present invention have generally been described with reference to a fingerprint biometric sensor. However, those skilled in the art will understand that the present invention is not limited to fingerprint biometric sensors, but that any type of biometric sensors may be implemented within another user interface component of an MU.

Those skilled in the art will also understand that some or all of the above described functionality may be implemented as software applications on the MU. That is, lines of code stored in a memory of the MU that may be executed by a processor of the MU.

It will be apparent to those skilled in the art that various modifications may be made in the present invention, without departing from the spirit or scope of the invention. Thus, it is intended that the present invention cover the modifications and variations of this invention provided they come within the scope of the appended claims and their equivalents.

What is claimed is:

1. A mobile device, comprising:
a user input component receiving input from a user; and
a biometric sensor incorporated in the user input component collecting biometric data from the user when the user input component is receiving the input, wherein the input is non-biometric data.

2. The mobile device of claim 1, wherein the user input component is an input key.

3. The mobile device of claim 2, wherein the input key is a portion of a main keypad of the device.

4. The mobile device of claim 1, wherein the user input component is one of a trigger device, a touch screen backlight control, a touch screen volume control, a phone keypad key and a soft key.

5. The mobile device of claim 1, wherein the biometric sensor is a fingerprint scanner.

6. The mobile device of claim 5, wherein the fingerprint scanner is one of an imaging scanner, a capacitance scanner, an ultrasonic scanner and a thermal scanner.

7. The mobile device of claim 1, wherein the biometric sensor is one of a retinal scanner and a voice analyzer.

8. The mobile device of claim 1, further comprising:
a memory storing authenticated biometric data; and
a processor receiving the collected biometric data from the biometric sensor and comparing it to the authenticated biometric data, wherein, if the collected biometric data does not match the authenticated biometric data, the processor locks the mobile device from further use.

9. The mobile device of claim 8, wherein the authenticated biometric data and the collected biometric data is fingerprint data.

10. The mobile device of claim 9, wherein the collected biometric data is a portion of a complete fingerprint.

11. A method, comprising:
receiving input from a user via a user input component of a mobile device; and
collecting biometric data from the user via a biometric sensor incorporated within the user input component when receiving the input from the user, wherein the input is non-biometric data.

12. The method of claim 11, further comprising:
storing the collected biometric data.

13. The method of claim 11, further comprising:
comparing the collected biometric data to stored biometric data.

14. The method of claim 13, wherein the stored biometric data is stored on one of the mobile device and an authentication server.

15. The method of claim 14, further comprising:
locking the mobile device from further use when the collected biometric data does not match the stored biometric data.

16. The method of claim 14, further comprising:
transmitting an alert when the biometric data does not match the stored biometric data.

17. The method of claim 11, wherein the biometric data is collected each time the user uses the user input component.

18. The method of claim 17 wherein the biometric data is one of stored locally on the mobile device and is transmitted to an authentication server.

19. The method of claim 11, wherein the user input component is one of an input key, a trigger device and a touch screen.

20. The method of claim 11, wherein the biometric sensor is one of a fingerprint scanner, a retinal scanner and a voice analyzer.

21. The method of claim 20, wherein the fingerprint scanner is one of an imaging scanner, a capacitance scanner, an ultrasonic scanner and a thermal scanner.

22. A mobile device, comprising:
an input means for receiving input from a user; and
a sensing means for collecting biometric data from the user when the input means is receiving the input, the sensing means being incorporated in the input means, wherein the input is non-biometric data.
